(19) United States
(12) Patent Application Publication
(10) Pub. No.: US 2005/0271300 A1
(43) Pub. Date: Dec. 8, 2005

(54) Image registration system and method

(76) Inventor: Robert K. Pina, Ramona, CA (US)

Correspondence Address: McDermott Will & Emery LLP, 28 State Street, Boston, MA, 02109, US

(21) Appl. No.: 10/858,773

(22) Filed: Jun. 2, 2004

(51) Int. Cl. G06K 9/32

(52) U.S. Cl. 382/294

(57) ABSTRACT

A method of characterizing alignment between two images includes receiving a first data set representative of a reference image, receiving a second data set representative of a target image, processing the first and second data sets that includes calculating an autocorrelation of the first data set to obtain a third data set that is substantially absent information representative of a relative shift between the reference image and the target image, and processing the third data set that includes calculating a Radon transform of the autocorrelation of the first data set to obtain a fourth data set that includes information representative of a relative rotational difference between the reference image and the target image.

### FIELD OF THE INVENTION

This invention relates to image processing and, more particularly, to image registration.

### BACKGROUND

As sequences of images are collected, for example by a motion picture camera, individual images may be misaligned due to the movement of the camera. In particular, camera movements occurring between the collecting of two sequential images may cause the second image to appear shifted in position and rotated relative to the previously collected image. Furthermore other image misalignments may be introduced such as scale changes, shear, and parallax due to camera optics. Considering misalignments due to relative shifting, rotating, and scaling differences, four parameters are needed to characterize these misalignments. To simultaneously estimate the four parameters, a non-linear inverse problem is solved that is computationally expensive (i.e., time consuming). In some applications such as collecting image sequences (e.g., video) with a camera mounted on an unmanned aerial vehicle (UAV), the excessive processing time for simultaneously estimating the four parameters negates the real time utility of such an approach because of the accumulating time lag between the raw video and the processed video.

### SUMMARY OF THE INVENTION

In one implementation, a method of characterizing alignment between two images includes receiving a first data set representative of a reference image, receiving a second data set representative of a target image, processing the first and second data sets that includes calculating an autocorrelation of the first data set to obtain a third data set that is substantially absent information representative of a relative shift between the reference image and the target image, and processing the third data set that includes calculating a Radon transform of the autocorrelation of the first data set to obtain a fourth data set that includes information representative of a relative rotational difference between the reference image and the target image.

One or more of the following features may also be included. The method may further include processing the first and second data sets to obtain a fifth data set that includes information representative of the relative shift between the reference image and the target image and substantially no information representative of the relative rotational difference between the reference image and the target image. The fourth data set may include information representative of a relative scaling difference between the reference image and the target image. Processing may include calculating an autocorrelation of the second data set. Processing may include calculating a Radon transform of the autocorrelation of the second data set. Processing may include summing values included in the Radon transform of the autocorrelation of the first data set. The method may further include processing the first and second data sets to obtain a residual estimate of relative rotational difference between the reference image and the target image.

In another implementation, a method of aligning two images includes receiving a first data set representative of a reference image, receiving a second data set representative of a target image, processing the first data set and the second data set that includes calculating an autocorrelation of the first data set to obtain a third data set that substantially includes no information representative of a relative shift between the reference image and the target image, processing the third data set that includes calculating a Radon transform of the autocorrelation of the first data set to obtain a relative rotational difference and a relative scaling difference between the reference image and the target image, compensating the second data set for the relative rotational difference and relative scaling difference, processing the first data set and the scaled and rotationally compensated second data set to obtain a fourth data set that includes information representative of the relative shift between the reference image and the target image, and compensating the scaled and rotationally compensated second data set for the relative shift.

One or more of the following features may also be included. Processing the first data set and the second data set to obtain the third data set may include calculating an autocorrelation of the second data set. Processing the third data set may include calculating a Radon transform of the autocorrelation of the second data set. Processing the first data set and the second data set may include applying an edge filter. Processing the third data set may include summing values included in the Radon transform.

In another implementation, a computer program product residing on a computer readable medium having a plurality of instructions stored thereon which, when executed by the processor, cause that processor to receive a first data set representative of a reference image, receive a second data set representative of a target image, process the first and second data sets that includes calculating an autocorrelation of the first data set to obtain a third data set that is substantially absent information representative of a relative shift between the reference image and the target image, and process the third data set that includes calculating a Radon transform of the autocorrelation of the first data set to obtain a fourth data set that includes information representative of a relative rotational difference between the reference image and the target image.

One or more of the following features may also be included. The computer program product may further include instructions for processing the first and second data sets to obtain a fifth data set that includes information representative of the relative shift between the reference image and the target image and substantially no information representative of the relative rotational difference between the reference image and the target image. The fourth data set may include information representative of a relative scaling difference between the reference image and the target image. The instructions to process the first and second data sets may include instructions for calculating an autocorrelation of the second data set. The instructions to process the first and second data sets may include instructions for calculating a Radon transform of the autocorrelation of the second data set. The instructions to process the first and second data sets may include instructions for summing values included in the Radon transform of the autocorrelation of the first data set. The computer program product may further include instructions for processing the first and second data sets to obtain a residual estimate of relative rotational difference between the reference image and the target image.

In another implementation, a computer program product residing on a computer readable medium having a plurality of instructions stored thereon which, when executed by the processor, cause that processor to receive a first data set representative of a reference image, receive a second data set representative of a target image, process the first data set and the second data set that includes calculating an autocorrelation of the first data set to obtain a third data set that substantially includes no information representative of a relative shift between the reference image and the target image, process the third data set that includes calculating a Radon transform of the autocorrelation of the first data set to obtain a relative rotational difference and a relative scaling difference between the reference image and the target image, compensate the second data set for the relative rotational difference and relative scaling difference, process the first data set and the scaled and rotationally compensated second data set to obtain a fourth data set that includes information representative of the relative shift between the reference image and the target image, and compensate the scaled and rotationally compensated second data set for the relative shift.

One or more of the following features may also be included. The instructions to process the first data set and the second data set to obtain the third data set may include instructions for calculating an autocorrelation of the second data set. The instructions to process the third data set may include instructions for calculating a Radon transform of the autocorrelation of the second data set. The instructions to process the first data set and the second data set may include instructions for applying an edge filter. The instructions to process the third data set may include instructions for summing values included in the Radon transform of the autocorrelation of the second data set.

In another implementation, an image registration system includes means for receiving a first data set representative of a reference image, means for receiving a second data set representative of a target image, means for processing the first and second data sets that includes calculating an autocorrelation of the first data set to obtain a third data set that is substantially absent information representative of a relative shift between the reference image and the target image, and means for processing the third data set that includes calculating a Radon transform of the autocorrelation of the autocorrelation of the first data set to obtain a fourth data set that includes information representative of a relative rotational difference between the reference image and the target image and substantially no information representative of a relative shift between the reference image and the target image.

One or more of the following features may also be included. The image registration system may further include a process for processing the first and second data sets to obtain a fifth data set that includes information representative of the relative shift between the reference image and the target image and substantially no information representative of the relative rotational difference between the reference image and the target image. The fourth data set may include information representative of a relative scaling difference between the reference image and the target image. Processing may include calculating an autocorrelation of the second data set. Processing may include calculating a Radon transform of the autocorrelation second data set. Processing may include summing values included in the Radon transform of the autocorrelation of the first data set. The image registration system may further include a process for processing the first and second data sets to obtain a residual estimate of relative rotational difference between the reference image and the target image.

In another implementation, an image registration system includes means for receiving a first data set representative of a reference image, means for receiving a second data set representative of a target image, means for processing the first data set and the second data set that includes calculating an autocorrelation of the first data set to obtain a third data set that substantially includes no information representative of a relative shift between the reference image and the target image, means for processing the third data set that includes calculating a Radon transform of the autocorrelation of the first data set to obtain a relative rotational difference and a relative scaling difference between the reference image and the target image, means for compensating the second data set for the relative rotational difference and relative scaling difference, means for processing the first data set and the scaled and rotationally compensated second data set to obtain a fourth data set that includes information representative of the relative shift between the reference image and the target image, and means for compensating the scaled and rotationally compensated second data set for the relative shift.

One or more of the following features may also be included. Processing the first data set and the second data set to obtain the third data set may include calculating an autocorrelation of the second data set. Processing the third data set may include calculating a Radon transform of the autocorrelation of the second data set. Processing the first data set and the second data set may include applying an edge filter. Processing the third data set may include summing values included in the Radon transform of the autocorrelation of the first data set.

In another implementation, a method of characterizing alignment between two images includes receiving a first data set representative of a reference image, receiving a second data set representative of a target image, transforming the first data set and the second data set from the spatial domain into the Fourier domain, filtering the Fourier transform of the first data set and the Fourier transform of the second data set, transforming the filtered Fourier transform of the first data set to obtain a third data set in the spatial domain and the filtered Fourier transform of the second data set to obtain a fourth data set in the spatial domain, and processing the third data set and the fourth data set to obtain a data set that is substantially absent information representative of a relative shift between the reference image and the target image.

One or more of the following features may also be included. Processing the third data set and the fourth data set may include calculating the autocorrelation of the third data set. The method may further include processing the data set that is substantially absent information representative of a relative shift between the reference image and the target image that includes calculating a Radon transform of the autocorrelation of the third data set to obtain a data set that includes information representative of a relative rotational difference between the reference image and the target image.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a block diagram depicting a system for collecting and aligning images.

FIG. 2 is diagram depicting misalignment of two sequentially collected images.

FIG. 3 is block diagram depicting images input into an image registration system and an output image.

FIG. 4 is a block diagram depicting portions of an image registration process.

FIG. 5 is a flow chart of a portion of an image partitioning process.

FIG. 6 is a flow chart of a portion of an image rotation estimator.

FIG. 7 is a flow chart of a portion of an image scaling estimator.

FIG. 8 is a flow chart of a portion of another embodiment of an image rotation estimator.

FIG. 9 is a flow chart of a portion of an image shift estimator.

FIG. 10 is a flow chart of a portion of a residue estimator.

### DETAILED DESCRIPTION OF THE PREFERRED EMBODIMENTS

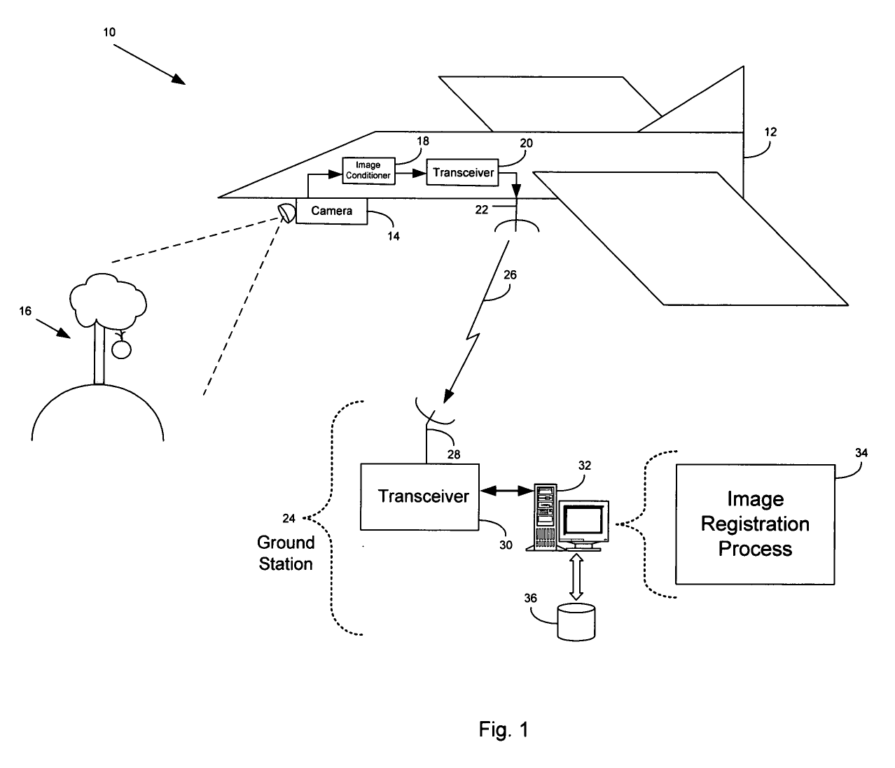

Referring to FIG. 1, a system 10 for collecting and processing aerial images includes an unmanned aerial vehicle (UAV) 12 in flight that has a camera 14 payload for collecting image sequences for applications such as battlefield monitoring, intelligence gathering, or other similar mission. Typically the camera 14 operates in the visual band to collect photographic images, however, in some arrangements the camera operates in the infrared band or other portion of the electromagnetic spectrum to collect images. The camera 14 collects a sequence of images as the UAV 12 flies over a photographic subject 16 (e.g., buildings, landscape, etc.) such as an apple tree. As the image sequence is collected by the camera 14, the images are passed to an image conditioner 18 which processes the images for storage and transmission. For example, the image conditioner 18 may add a unique time stamp or data representing the location of the UAV 12 (e.g., a GPS location) to each image collected. In some arrangements the image conditioner 18 compresses the images into a digital format that can be relatively quickly transmitted from the UAV 12. In this example the processed images are sent to a transceiver 20 that encodes the images or a portion of the images into a wireless signal for transmission from the UAV 12 to a ground station 24. Once the images are encoded into a wireless signal, the signal is sent to an antenna 22 that is mounted on the external surface of the UAV 12. To transmit the images to the ground station 24, a wireless link 26 is established between the UAV antenna 22 and an antenna 28 located at the ground station 24. Typically, a radio frequency (RF) link is established between the antennas 22, 28, however in some arrangements infrared, laser, or other wireless links are established. Furthermore, besides single link, multiple wireless links of similar (e.g., RF to RF) or different (e.g. RF to infrared) types may be established to transmit wireless signals between the UAV 12 and the ground station 24.

Upon receiving the wireless signal, the signal propagates from the antenna 28 to a transceiver 30 for decoding and processing (e.g., analog to digital converting, etc.) the sequence of images included in the wireless signal. Once decoded and processed, the images are sent to a computer system 32 that is in communication with the transceiver 30 for further processing such as alignment of adjacent images in the sequence. To align the images, an image registration process 34 is executed in memory (e.g., random access memory, read-only memory, etc) included in computer system 32. In this arrangement, computer system 32 is in communication with a storage device 36 (e.g., a hard drive, CD-ROM, etc.) that is used for storing the collected images prior to processing with the image registration process 34 and/or for storing the post-processed images. Additionally, the storage device 26 can store other data such as the images collected by other UAV or other types of mobile (e.g., airplanes, ships, automobiles, etc.) or stationary (e.g., building-mounted cameras, etc.) platforms. In this particular arrangement the images are aligned at the ground station 24 by the image registration process 34, however, in other arrangements, image alignment is performed on-board the UAV 12 by executing the image registration process 34 with the image conditioner 18.

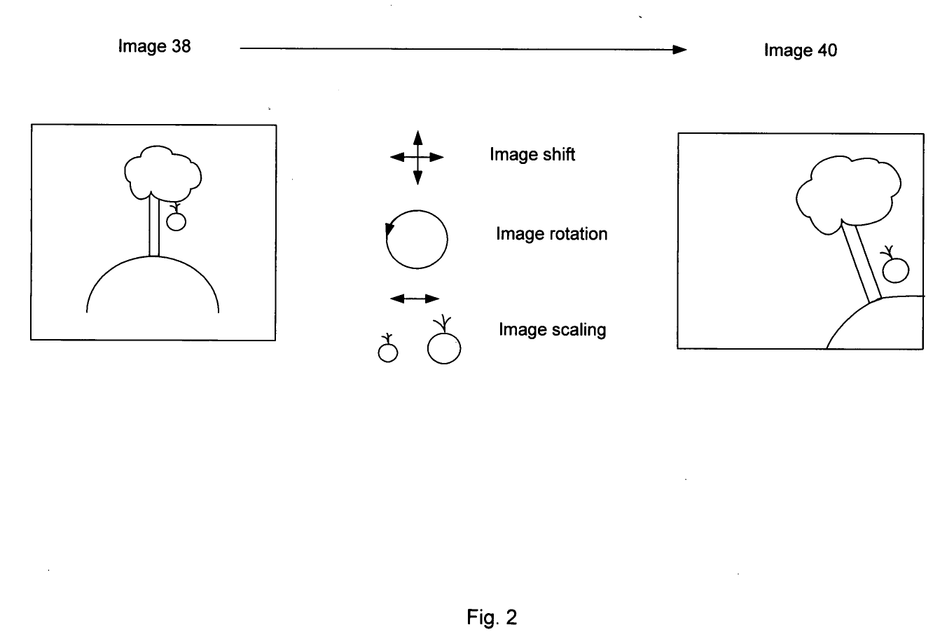

Referring to FIG. 2, in one collection mode the UAV 12 collects sequences of images such as frames of a video motion picture. Due to the motion (e.g., a banking maneuver) of the UAV 12 during flight, the aspect of the camera 14 may change on a frame-by-frame basis. For a demonstrative example, camera 14 sequentially collects image 38 and image 40 while the UAV 12 is in flight. Due to the motion of UAV 12, the aspect of camera 14 changes from the time image 38 is collected to the time image 40 is collected. Due to this aspect change, image 40 is misaligned relative to image 38. In this application image misalignment can be characterized by three components. Relative movement in the x-y plane, referred here as “shifting”, can be characterized between the image 38 and image 40. Also, a relative rotational difference, due to motion of the UAV 12, can be estimated. The third misalignment component represents a scaling difference between the two sequentially collected images. In some arrangements scaling differences occur when the magnification level of camera 14 is increased (e.g., zoom in) or decreased (e.g., zoom out) between image collections. By estimating these relative shift, rotation, and scaling differences, the second collected image (e.g. image 40) can be corrected relative to the first image collected (e.g., image 40).

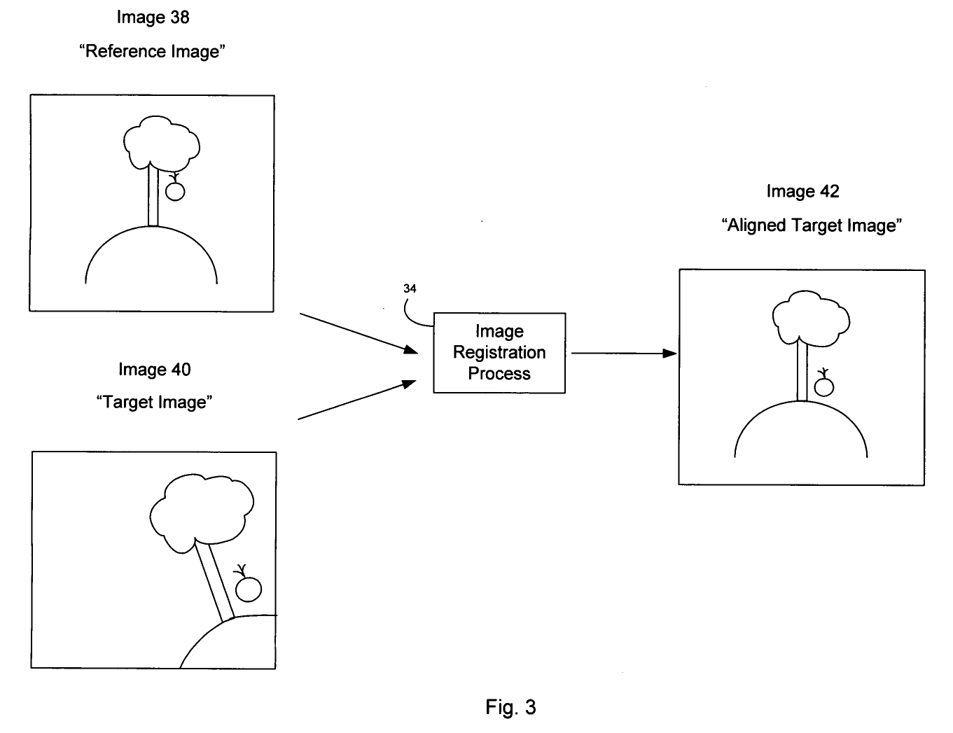

Referring to FIG. 3, in this particular arrangement, to estimate and compensate for misalignment, data sets representing two sequentially collected images are input into the image registration process 34 to correct the image collected second for misalignment. For example, the first of the sequentially collected images (e.g., image 38), referred to here as the “reference image”, and the image collected second (e.g., image 40), referred to here as the “target image”, are input into the image registration process 34 for estimating the relative shift, rotation, and scale differences between the images. Once estimated, the image registration process 34 compensates the target image (e.g., image 40) for the relative misalignments and produces an aligned target image 42. In some arrangements, once produced, the aligned target image 42 can replace target image 40 in the image sequence to reduce relative movement and jitter when the image sequence is presented to a viewer.

Typically the relative shift, rotation, and scale differences between the images are used to generate alignment parameters for compensating the target image 40 to produce the aligned image 42. These alignment parameters can then be stored for use in aligning the next sequentially collected image. In some arrangements, to align the next image in the sequence, the unaligned target image 40 is used as the reference image and a second set of alignment parameters are generated from the new reference image and the new target image (e.g., next image in the sequence). The second set of alignment parameters are combined with the previous alignment parameters (i.e., generated from images 38 and 40) to produce parameters that provide a net compensation for the new target image. Typically, this procedure is repeated for each of the collected images in the sequence. Alternatively, in some arrangements, the aligned target image 42 is used as a reference image with respect to the next sequentially collected image and alignment parameters are determined between this new reference image and the next image in the sequence to be compensated. Similarly this procedure can be used in a repetitive fashion for each of the images collected in a sequence. Furthermore, in some arrangements, only particular video frames are selected to provide a reference frame. For example, every fifth image in a sequence of collected images may be used as a reference image for the next four consecutive images in the sequence. In still another example, only a single image (e.g., the first image) in a collected sequence of images may be used as a reference image.

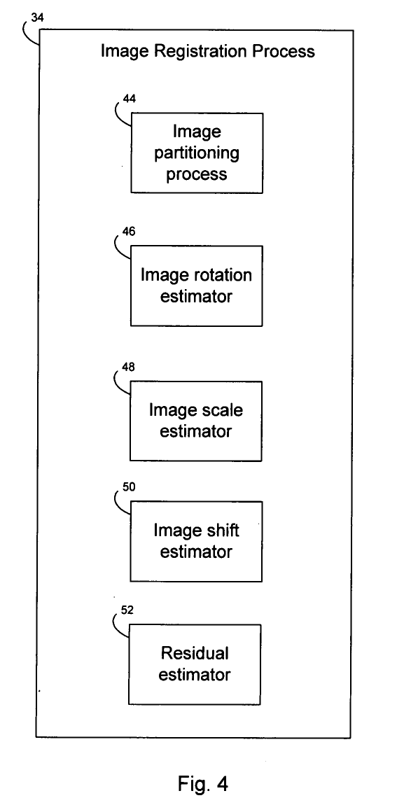

Referring to FIG. 4, the image registration process 34 includes processes for estimating relative differences and aligning a target image with respect to a reference image. To estimate the shift, rotation, and scale differences, a 4-dimensional non-linear inverse problem is presented that is relatively computationally time-consuming to simultaneously solve for each of the differences. However, by partitioning the problem, each of the differences are estimated separately. In particular, by separating the estimations, the estimation of the shift and rotation are linearized and only the estimation of the scaling difference remains a non-linear inverse problem. However, the scaling difference estimation is now 1-dimensional rather than 4-dimensional. By reducing the complexity of the parameter estimation, the computational burden is significantly reduced and the computational speed is significantly increased for a fixed amount of computing power. Also, by increasing computational speed, processing time is conserved that can be used for executing related or unrelated processes thereby improving computational efficiency.

This arrangement, the image registration process 34 includes an image partitioning process 44 that is used to partition information from the reference and target image pertaining to the relative shift between the images while preserving rotational and scaling information. Once the shift information is partitioned out, an image rotation estimator 46 estimates the relative rotational misalignment between the two images. The image registration process 34 also includes an image scale estimator 48 that estimates the relative scaling difference between the reference image and the target image. Once estimates for the relative rotational and scaling differences are determined, an image shift estimator 50 compensates the target image for rotation and scale estimates. Additionally, the image shift estimator 50 estimates the shift between the target image and the reference image and compensates the target image for the shift difference. The image registration process 34 also includes a residual estimator 52 that produces residual estimates of the shift, rotation, and scaling parameters and compensates the target image for these estimates. In one arrangement the residual estimator 52 estimates and compensates in an iterative fashion until the estimated residuals converge to a minimal value such as zero or to within a specified tolerance.

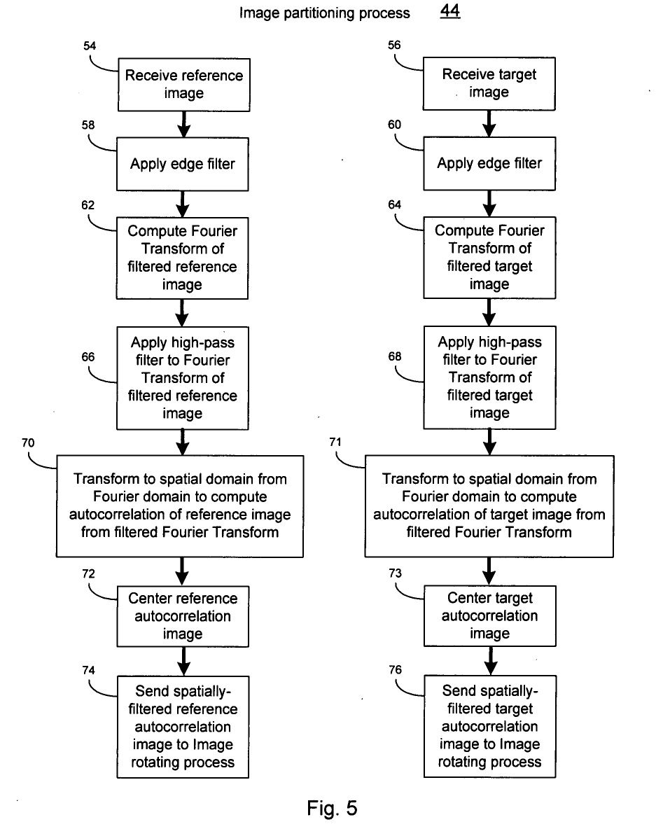

Referring to FIG. 5, the image partitioning process 44 is presented to include with two separate flow chart paths that represent the processing of the reference image (e.g., image 38) and the target image (e.g., image 40). The image partitioning process 44 includes respectively receiving 54, 56 data sets representing the reference image and data representing the target image. Once received, the image partitioning process 44 respectively applies 58, 60 edge filters to the reference image data and target image data. In general, the geometry for defining a coordinate system in an image are object edges or other types of boundaries. Depending on lighting conditions, these edges can be “hard” or “soft”. For example, in rural scenes, terrain features such as coastlines, rivers, valleys, and mountain ranges can present hard edges at visible wavelengths depending upon illumination conditions and scattering properties. At thermal wavelengths variations in thermal properties provide distinct edges. In some arrangements, a Sobel, Roberts, Laplacian-of-Gaussian, or other similar edge filter is implemented. By applying an edge filter to the images, the robustness of image registration improves against the effects of contrast and intensity variations between images. Additionally, application of an edge filter effectively “de-means” the images and mitigates against artifact generation due to otherwise abrupt changes at image edges.

After respectively applying 58, 60 the edge filters to the reference and target image, the image partitioning process 44 respectively computes 62, 64 two-dimensional Fourier Transforms of the filtered reference image and target image to transform the images from the spatial domain to the Fourier domain. Typically the data is transformed from the spatial domain into the Fourier domain by executing a Fast Fourier Transform (FFT) or other similar processing techniques. Once the data is transformed from the spatial domain into the Fourier domain, the image partitioning process 44 respectively squares the magnitude of each Fourier Transform and applies 66, 68 high-pass filter coefficients to the squared magnitude of each transform. Alternatively, in some arrangements the image partitioning process 44 may apply the high-pass filter coefficients to the Fourier Transforms prior to computing the magnitude squared of each transform. By applying the high-pass filter coefficients, “local” spatial structures in the images are emphasized and potentially algorithm robustness is improved. However, in some embodiments the images are not high-pass filtered. Furthermore, in some embodiments the edge filters may be applied 58, 60 to the image data after being transformed into the Fourier domain.

After high-pass filtering 66, 68, the image partitioning process 44 respectively transforms 70, 71 each of the filtered Fourier Transforms back to the spatial domain using an inverse Fourier Transform such as an Inverse Fast Fourier Transform (IFFT) to respectively compute the autocorrelation of the reference image and the target image. By transforming back into the spatial domain, the reference and target images are relatively smoothed, compared to remaining in the Fourier domain, and typically provide distinct autocorrelation peak values. The respective autocorrelations preserve rotational and scale information while eliminating shift information from the reference image autocorrelation data and the target image autocorrelation data. By partitioning shift information from the images, the translational estimation is decoupled while rotational and scale estimation are left intact. After transforming 70, 71 back into the spatial domain to attain the autocorrelations, the image partitioning process 44 respectively centers 72, 73 the reference autocorrelation image and the target autocorrelation image (i.e. places the “zero” lag position at center). Dependent upon the autocorrelation computations (e.g., programming language implemented), in some arrangements the image partitioning process 44 does not need to center the autocorrelation images.

After the autocorrelation images are computed and centered, the image partitioning process 44 respectively sends 74, 76 the spatially-filtered reference and target autocorrelation images to the image rotation estimator 46 to estimate the relative rotation between the two images.

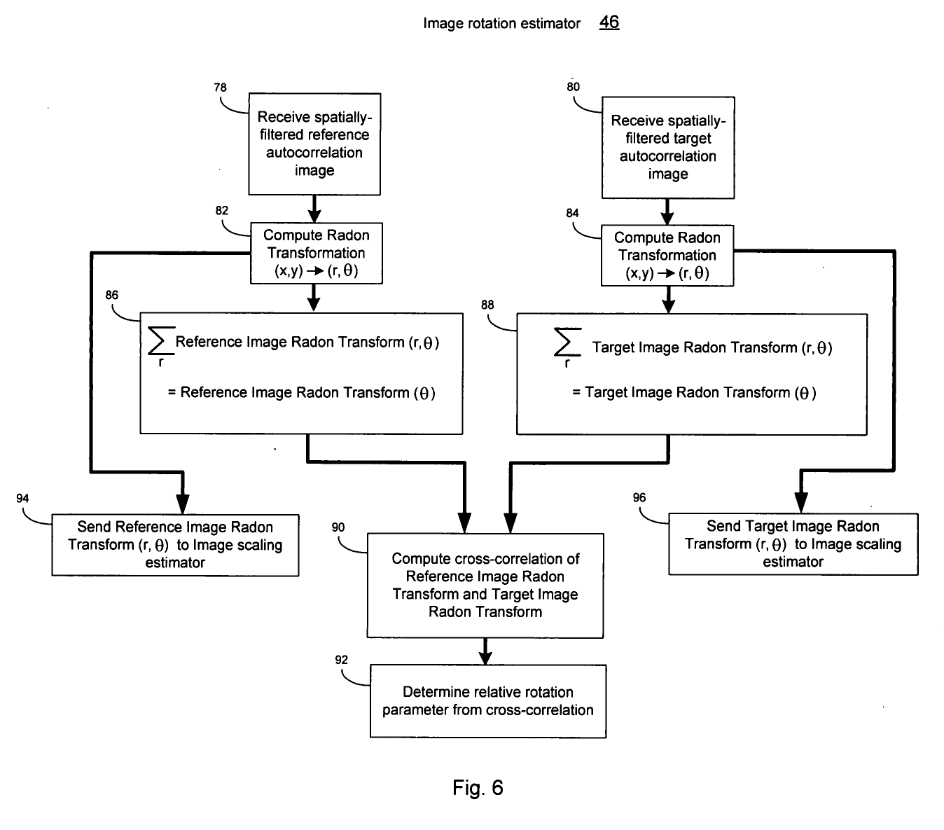

Referring to FIG. 6, the image rotating process 46 includes respectively receiving 78, 80 the spatially-filtered reference and target autocorrelation images for estimating relative rotational differences. The image rotating process 46 continues the partitioning to reduce computational complexity by isolating the estimations of the relative rotational and scale differences. By isolating differences, estimations are determined independently thereby reducing them to two independent single parameter estimation problems.

To separate the rotation and scale estimates, the image rotating process 46 respectively computes a Radon transformation of both the reference autocorrelation image and the target autocorrelation image. In particular, the image rotation estimator 46 computes 82 the Radon transformation of the spatially-filtered reference autocorrelation image and computes 84 the Radon transformation of the spatially-filtered target autocorrelation image. The Radon transformation transforms an image in which the location of each point of the image is represented by a Cartesian coordinate pair (x, y) into an image where the location of each point is represented by a Cartesian coordinate pair (r,θ) where “r” is the radial distance to the point from the Cartesian origin and “θ” is the angular position about the origin. A particular value of a transformed image associated with a particular (r, θ) pair is equal to the sum along a straight line through the original image where this summing line is perpendicular to the line from the origin (i.e., image center) to the coordinates in the original image defined by the r, θ pair via the variable transformation x=r cos (θ), y=r sin (θ).

To determine the relative rotational difference between the reference and the target image, the radial components are removed from the respective Radon transformations. In this arrangement, the image rotating process 46 sums 86 the reference image Radon transform over all radial coordinates (r) and sums 88 the target image Radon transform over all radial coordinates (r). This summing, referred to as “averaging out”, collapses each image to a one-dimensional vector of values that are a function of angular coordinate (θ). In this representation, the relative rotational difference between the images appears as a linear shift between the two vectors. This shift, or relative rotational difference, can be estimated by computing a one-dimensional cross-correlation function of the two vectors and determining the lag corresponding to the peak level of the cross-correlation. In this arrangement, the image rotation estimator 46 computes 90 the cross-correlation of the reference image Radon transform and the target image Radon transform and then determines 92 the relative rotational difference from the cross-correlation of the two transforms. Typically, to determine the rotational difference, the image rotation estimator 46 detects the peak level of the cross-correlation which corresponds to the shift in the two transforms. In order to estimate the relative scaling difference between the reference image and the target image, the Radon transformations are also used by the image scale estimator 48 included in the image registration process 34. For estimating the relative scaling difference, the image rotation estimator 46 respectively sends 94, 96 the reference image Radon transform and the target image Radon transform to the image scale estimator 48.

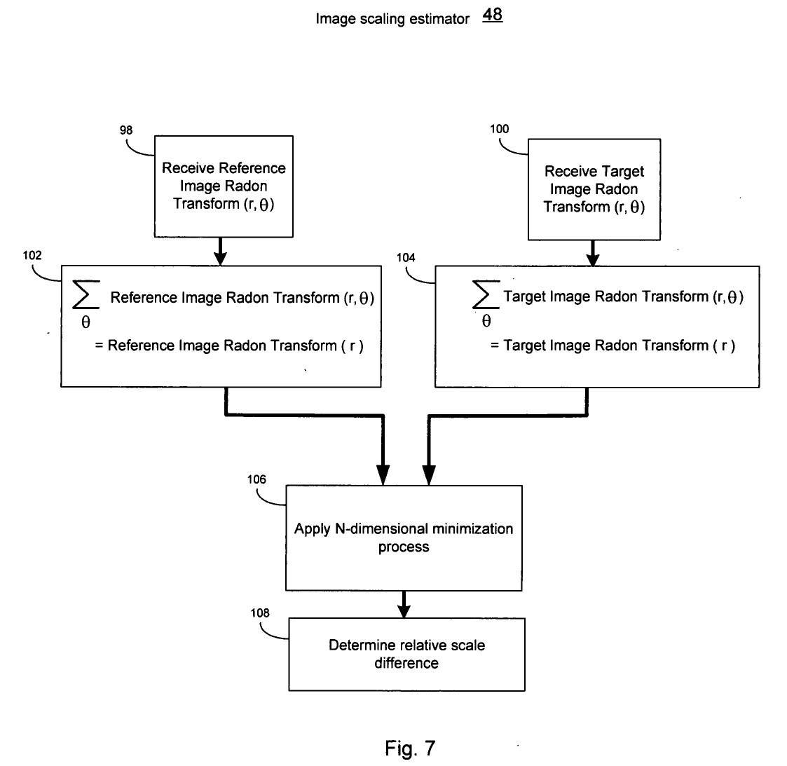

Referring to FIG. 7, the image scale estimator 48 estimates the relative scaling difference between the reference image and the target image from the Radon transforms of the autocorrelations of the data that represent the two images. The image scale estimator 48 respectively receives 98, 100 the reference image Radon transformation and the target image Radon transformation. Similar to the image rotation estimator 46, the image scale estimator 48 “averages out” a component from the Radon transforms to determine the relative scaling difference. In this arrangement the image scale estimator 48 respectively “averages out” the angular coordinate of the Radon transforms. In particular, the image scale estimator 48 sums 102 the reference image Radon transform over the range of θ. Similarly, the image scale estimator 48 sums 104 over the range of angular coordinates of target image Radon transform. By “averaging out” the angular coordinates, both the reference and target image Radon transforms collapse to one-dimensional vectors that are a function of the radial coordinate “r”. Determining the scaling difference calls for solving a one-dimensional non-linear estimation problem of the form f(x)=g(ax) where “a” is the scaling difference. To determine the scaling difference, the image scaling process 48 applies 106 an “N”-dimensional minimization process (e.g., variable metric, conjugate gradient, direction set, etc.) to the data vector. By applying the minimization process the image scale estimator 48 can determine 108 the relative scaling difference between the two images. Alternatively, for small scale differences, the scale estimation can be linearized and a direct estimate of the scale difference can be obtained via linear inversion.

In some arrangements, due to relatively complex spatial structures represented in the images, determination of the scaling difference between the reference and target image can be problematic and extracting the scaling difference between the images can be difficult.

In some image collecting applications, such from the UAV 12, due to the collection rate, a unity scaling factor on a frame-by-frame basis is typically a valid assumption. Based on this assumption of a unity scaling difference, estimating the scaling difference can be bypassed. By removing the scaling estimation, a complete Radon transformation of the data representing the autocorrelations of the reference and target images is not needed to determine the relative rotation difference between the images. Rather, only the Radon transformation corresponding to a radial coordinate value of zero need be computed in order to determine the relative rotation difference. In particular, a partial extraction of angular information contained in the pair of autocorrelation images computed by the image partitioning process 44 may be determined by summing the autocorrelation image values along straight lines that pass through the respective image centers for a specified set of angular positions. From the respective two one-dimensional vectors produced from the summations, the relative shift between the vectors produces the relative rotation between the reference and target images.

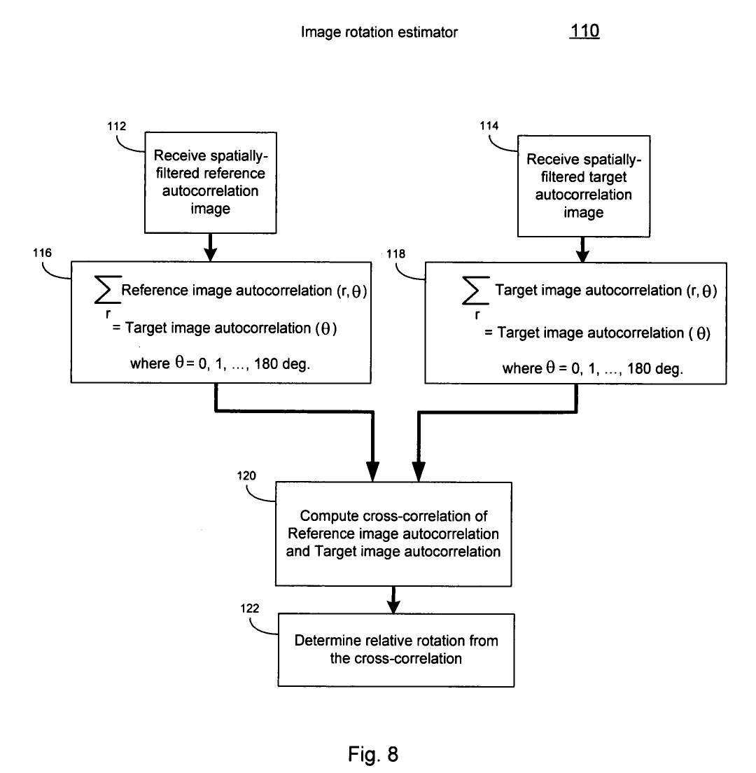

Referring to FIG. 8, a flow chart of an image rotation estimator 110 similar to the image rotation estimator 48 shown in FIG. 6 is presented, however, by assuming a unity scaling factor between the reference and target images, complete Radon transforms for each image are not computed. Rather, the Radon transformation corresponding to a radial coordinate value of zero is computed. The image rotation estimator 110 includes respectively receiving 112 the reference and target spatially-filtered image autocorrelations computed by the image partitioning process 44. To collapse the reference image autocorrelation into a one-dimensional vector, the image rotation estimator 110 sums 116 the autocorrelation values along a straight line that passes through the autocorrelation origin for a specified set of angular positions. In this particular example, the autocorrelation values are summed along straight lines for θ=0 deg. to θ=180 deg. in 1 degree steps. Similarly, the image rotation estimator 110 sums 118 values of the target image autocorrelation along straight lines passing through the origin for the same angular positions (e.g., θ=0 deg. to θ=180 deg. with a 1 degree step). By respectively summing the autocorrelation functions of the reference and target images, the autocorrelations respectively collapse to one-dimensional vectors that are a function of θ. After computing the sums, the image rotation estimator 110, computes 120 the cross-correlation of the one-dimensional reference image autocorrelation as a function of θ and the one-dimensional target image autocorrelation as a function of θ. Similar to the image rotation estimator 46 (shown in FIG. 6), the relative shift between the two one-dimensional vectors provides the rotational difference between the reference and target image. The image rotation estimator 110, determines 122 the relative rotation difference from the cross-correlation of the two autocorrelations. For example, the process detects the peak value of the cross-correlation function which corresponds to the relative rotational shift. By computing the Radon transformation for the radial coordinate value of zero, interpolating and summing operations are combined to increase computational speed and efficiency for determining the relative rotational difference. Furthermore, by using the Radon transformations, rather than some other Cartesian to polar coordinate system transformations (e.g., transform pair x=r cos (θ), y=r sin (θ)), linear interpolations are computed rather than bilinear interpolations (i.e., linear interpolation in two dimensions).

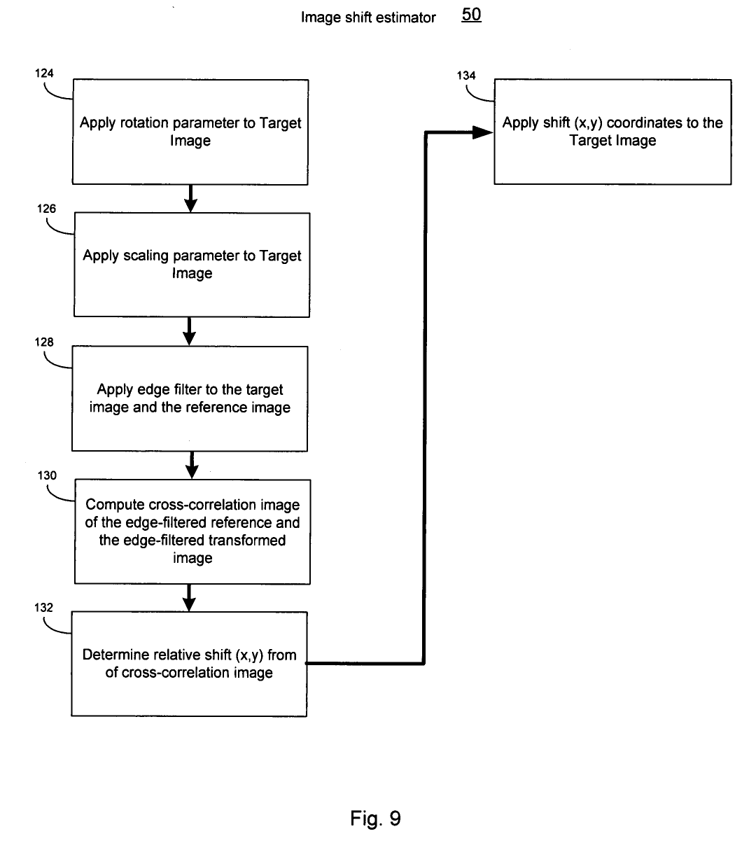

Referring to FIG. 9, after the relative rotational and scaling differences are determined, the image shift estimator 50 compensates the target image and determines the relative shift between the reference and target images. In this particular arrangement, the image shift estimator 50 applies 124 the relative rotational difference to the target image that is calculated, for example, by the image rotation estimator 44 (shown in FIG. 6) or image rotation estimator 110 (shown in FIG. 8). The image shift estimator 50 also applies 126 the scaling difference to the target image, however, in some arrangements this step is bypassed, for example, if a unity scaling difference is assumed between the reference image and the target image. After applying the relative rotation and scaling compensations, the image shift estimator 50 applies 128 an edge filter to the target image and the reference image. However, in some arrangements (e.g. to increase computational speed), edge filtering occurs prior to compensating the target image for relative rotational and scaling differences.

Once the target image has been compensated for the relative rotation and scaling differences, the image shift estimator 50, computes 130 the cross-correlation of the edge-filtered reference image and the edge-filtered target image. In some arrangements the cross-correlation is calculated using a Fast Fourier Transform, however, other cross-correlation methodologies may be implemented. Once the cross-correlation is calculated, the image shift estimator 50 determines 132 the relative vertical and horizontal shift between the reference and target images from the cross-correlation image. Typically, the shift is determined by detecting the peak value of the cross-correlation and determining the x-axis and y-axis coordinates associated with the peak cross-correlation value. In some arrangements the cross-correlation images show broad, low spatial-frequency structure with a narrow peak associated with the correct image-to-reference offset. Typically the correlation peak is usually narrow because the edge-filtered images are effectively line drawings and correlated pixels occur at line intersection points between the images. However, in some arrangements a high-pass filter is applied to the cross-correlation image to reduce the effects of a broad correlation peak that potentially can introduce errors in peak detection. After computing the cross-correlation image 130, the image shift estimator 50 determines 132 the relative shift between the reference image and the target image. Typically, the relative shift is determined by detecting the cross-correlation image peak value and determining the x and y axis offsets corresponding to the peak value. After determining the x and y axis offsets, the image shift estimator 50 applies 134 the x and y axis offsets to the target image to compensate for the relative shift. These rotational, scaling, and shift differences can be used as alignment parameters along with alignment parameters determined between the unaligned target image and the next sequentially collected image to compensate the next image. However, in some arrangements the target image may be further adjusted for residual effects.

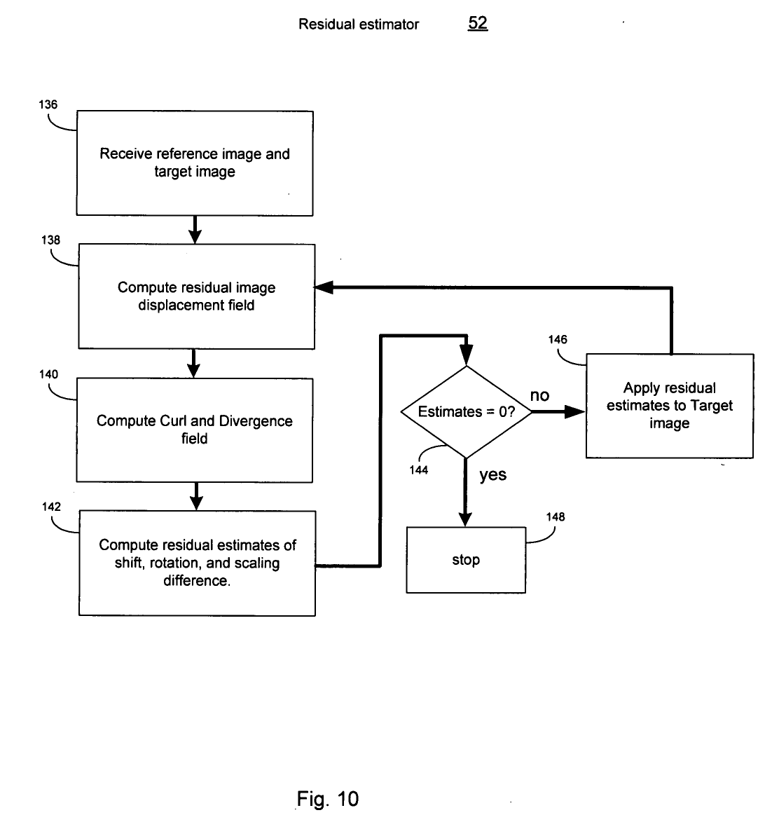

Referring to FIG. 10, to estimate and apply residual corrections to the target image, the residual estimator 52 is executed. The residual estimator 52 includes receiving 136 the reference image and the target image and computing 138 a residual image displacement field. In some arrangements, the residual image displacement field is determined by using the numerical gradients of the reference image, a pixel-by-pixel difference in the values between the target image and the reference image, and a minimum displacement constraint. After computing the residual image displacement field, the residual estimator 52, computes 140 a curl and divergence field. In this arrangement, to compute the curl and divergence field, the residual estimator 52 uses the residual image displacement field. The residual estimator 52 then computes 142 residual estimates of the relative rotation, shift, and scaling differences. To compute the residuals, the residual estimator 52 uses the residual image displacement field, the curl field and the divergence field. After the residuals are computed, the residual estimator 52 determines 144 if the residual estimates have converged to zero. If the estimates have not converged to zero, the residual estimator 52 applies 146 the residual estimates to the target image and returns to compute 138 another iteration of the residual image displacement field, curl and divergence fields, and residual estimates. If the estimates have converged to zero or to a certain specified tolerance, the residual estimator 52 stops 148.

While the image registration process 34 is shown as being executed on a computer system 32, other configurations are possible. For example, the image registration process 34 may be executed on a server, laptop computer, or a handheld device, such as a cellular telephone, or a personal digital assistant (e.g. a Palm™ or Pocket PC™ handheld device, not shown). Also, the image registration process 34 may be implemented in an Application Specific Integrated Circuit (ASIC) or other customized electronic circuit. Furthermore, the image registration process 34 can be implemented to various interpretive or compliable computer languages such as the source code embodiment listed in Appendix A.

A number of implementations have been described. Nevertheless, it will be understood that various modifications may be made. Accordingly, other implementations are within the scope of the following claims.

1. A method of characterizing alignment between two images comprising:
receiving a first data set representative of a reference image;
receiving a second data set representative of a target image;
processing the first and second data sets that includes calculating an autocorrelation of the first data set to obtain a third data set that is substantially absent information representative of a relative shift between the reference image and the target image; and
processing the third data set that includes calculating a Radon transform of the autocorrelation of the first data set to obtain a fourth data set that includes information representative of a relative rotational difference between the reference image and the target image.

2. The method of claim 1 further comprising:
processing the first and second data sets to obtain a fifth data set that includes information representative of the relative shift between the reference image and the target image and substantially no information representative of the relative rotational difference between the reference image and the target image.

3. The method of claim 1 wherein the fourth data set includes information representative of a relative scaling difference between the reference image and the target image.

4. The method of claim 1 wherein processing includes calculating an autocorrelation of the second data set.

5. The method of claim 4 wherein processing includes calculating a Radon transform of the autocorrelation of the second data set.

6. The method of claim 1 wherein processing includes summing values included in the Radon transform of the autocorrelation of the first data set.

7. The method of claim 1 further comprising:
processing the first and second data sets to obtain a residual estimate of relative rotational difference between the reference image and the target image.

8. A method of aligning two images comprising:
receiving a first data set representative of a reference image;
receiving a second data set representative of a target image;
processing the first data set and the second data set that includes calculating an autocorrelation of the first data set to obtain a third data set that substantially includes no information representative of a relative shift between the reference image and the target image;
processing the third data set that includes calculating a Radon transform of the autocorrelation of the first data set to obtain a relative rotational difference and a relative scaling difference between the reference image and the target image;
compensating the second data set for the relative rotational difference and relative scaling difference;
processing the first data set and the scaled and rotationally compensated second data set to obtain a fourth data set that includes information representative of the relative shift between the reference image and the target image; and
compensating the scaled and rotationally compensated second data set for the relative shift.

9. The method of claim 8 wherein processing the first data set and the second data set to obtain the third data set includes calculating an autocorrelation of the second data set.

10. The method of claim 9 wherein processing the third data set includes calculating a Radon transform of the autocorrelation of the second data set.

11. The method of claim 8 wherein processing the first data set and the second data set includes applying an edge filter.

12. The method of claim 8 wherein processing the third data set includes summing values included in the Radon transform.

13. A computer program product residing on a computer readable medium having a plurality of instructions stored thereon which, when executed by the processor, cause that processor to:
receive a first data set representative of a reference image;
receive a second data set representative of a target image;
process the first and second data sets that includes calculating an autocorrelation of the first data set to obtain a third data set that is substantially absent information representative of a relative shift between the reference image and the target image; and
process the third data set that includes calculating a Radon transform of the autocorrelation of the first data set to obtain a fourth data set that includes information representative of a relative rotational difference between the reference image and the target image.

14. The computer program product of claim 13 further comprising instructions for:
processing the first and second data sets to obtain a fifth data set that includes information representative of the relative shift between the reference image and the target image and substantially no information representative of the relative rotational difference between the reference image and the target image.

15. The computer program product of claim 13 wherein the fourth data set includes information representative of a relative scaling difference between the reference image and the target image.

16. The computer program product of claim 13 wherein the instructions to process the first and second data sets include instructions for:
calculating an autocorrelation of the second data set.

17. The computer program product of claim 16 wherein the instructions to process the first and second data sets include instructions for:
calculating a Radon transform of the autocorrelation of the second data set.

18. The computer program product of claim 13 wherein the instructions to process the first and second data sets include instructions for:
summing values included in the Radon transform of the autocorrelation of the first data set.

19. The computer program product of claim 13 further comprising instructions for:
processing the first and second data sets to obtain a residual estimate of relative rotational difference between the reference image and the target image.

20. A computer program product residing on a computer readable medium having a plurality of instructions stored thereon which, when executed by the processor, cause that processor to:
receive a first data set representative of a reference image;
receive a second data set representative of a target image;
process the first data set and the second data set that includes calculating an autocorrelation of the first data set to obtain a third data set that substantially includes no information representative of a relative shift between the reference image and the target image;
process the third data set that includes calculating a Radon transform of the autocorrelation of the first data set to obtain a relative rotational difference and a relative scaling difference between the reference image and the target image;
compensate the second data set for the relative rotational difference and relative scaling difference;
process the first data set and the scaled and rotationally compensated second data set to obtain a fourth data set that includes information representative of the relative shift between the reference image and the target image; and
compensate the scaled and rotationally compensated second data set for the relative shift.

21. The computer program product of claim 20 wherein the instructions to process the first data set and the second data set to obtain the third data set include instructions for:
calculating an autocorrelation of the second data set.

22. The computer program product of claim 21 wherein the instructions to process the third data set include instructions for:
calculating a Radon transform of the autocorrelation of the second data set.

23. The computer program product of claim 20 wherein the instructions to process the first data set and the second data set include instructions for:
applying an edge filter.

24. The computer program product of claim 22 wherein the instructions to process the third data set include instructions for:
summing values included in the Radon transform of the autocorrelation of the second data set.

25. An image registration system comprising:
means for receiving a first data set representative of a reference image;
means for receiving a second data set representative of a target image;
means for processing the first and second data sets that includes calculating an autocorrelation of the first data set to obtain a third data set that is substantially absent information representative of a relative shift between the reference image and the target image; and
means for processing the third data set that includes calculating a Radon transform of the autocorrelation of the first data set to obtain a fourth data set that includes information representative of a relative rotational difference between the reference image and the target image and substantially no information representative of a relative shift between the reference image and the target image.

26. The image registration system of claim 25 further comprising:
means for processing the first and second data sets to obtain a fifth data set that includes information representative of the relative shift between the reference image and the target image and substantially no information representative of the relative rotational difference between the reference image and the target image.

27. The image registration system of claim 25 wherein the fourth data set includes information representative of a relative scaling difference between the reference image and the target image.

28. The image registration system of claim 25 wherein processing includes calculating an autocorrelation of the second data set.

29. The image registration system of claim 28 wherein processing includes calculating a Radon transform of the autocorrelation of the second data set.

30. The image registration system of claim 25 wherein processing includes summing values included in the Radon transform of the autocorrelation of the first data set.

31. The image registration system of claim 25 further comprising:
means for processing the first and second data sets to obtain a residual estimate of relative rotational difference between the reference image and the target image.

32. An image registration system comprising:
means for receiving a first data set representative of a reference image;
means for receiving a second data set representative of a target image;
means for processing the first data set and the second data set that includes calculating an autocorrelation of the first data set to obtain a third data set that substantially includes no information representative of a relative shift between the reference image and the target image;
means for processing the third data set that includes calculating a Radon transform of the autocorrelation of the first data set to obtain a relative rotational difference and a relative scaling difference between the reference image and the target image;
means for compensating the second data set for the relative rotational difference and relative scaling difference;
means for processing the first data set and the scaled and rotationally compensated second data set to obtain a fourth data set that includes information representative of the relative shift between the reference image and the target image; and
means for compensating the scaled and rotationally compensated second data set for the relative shift.

33. The image registration system of claim 31 wherein processing the first data set and the second data set to obtain the third data set includes calculating an autocorrelation of the second data set.

34. The image registration system of claim 33 wherein processing the third data set includes calculating a Radon transform of the autocorrelation of the second data set.

35. The image registration system of claim 32 wherein processing the first data set and the second data set includes applying an edge filter.

36. The image registration system of claim 32 wherein processing the third data set includes summing values included in the Radon transform of the autocorrelation of the first data set.

37. A method of characterizing alignment between two images comprising:
receiving a first data set representative of a reference image;
receiving a second data set representative of a target image;
transforming the first data set and the second data set from the spatial domain into the Fourier domain;
filtering the Fourier transform of the first data set and the Fourier transform of the second data set;
transforming the filtered Fourier transform of the first data set to obtain a third data set in the spatial domain and the filtered Fourier transform of the second data set to obtain a fourth data set in the spatial domain; and
processing the third data set and the fourth data set to obtain a data set that is substantially absent information representative of a relative shift between the reference image and the target image.

38. The method of claim 37 wherein processing the third data set and the fourth data set includes calculating the autocorrelation of the third data set.

39. The method of claim 38 further comprising:
processing the data set that is substantially absent information representative of a relative shift between the reference image and the target image that includes calculating a Radon transform of the autocorrelation of the third data set to obtain a data set that includes information representative of a relative rotational difference between the reference image and the target image.
